(19) United States
(12) Patent Application Publication
(10) Pub. No.: US 2020/0187292 A1
(43) Pub. Date: Jun. 11, 2020

(54) ACKNOWLEDGEMENT OF SYSTEM INFORMATION REQUEST

(71) Applicant: NOKIA TECHNOLOGIES OY, Espoo (FI)

(72) Inventors: Samuli Heikki Turtinen, Ii (FI); Juho Mikko Oskari Pirskanen, Kangasala (FI); Timo Koskela, Oulu (FI); Sami-Jukka Hakola, Kempele (FI); Jorma Johannes Kaikkonen, Oulu (FI)

(21) Appl. No.: 16/625,596

(22) PCT Filed: May 23, 2018
(86) PCT No.: PCT/EP2018/063442

§ 371 Date: Dec. 20, 2019

Related U.S. Application Data
(60) Provisional application No. 62/524,122, filed on Jun. 23, 2017.

(51) Int. Cl. H04W 76/27; H04L 5/00; H04W 74/08

(52) U.S. Cl. CPC H04W 76/27; H04W 84/042; H04W 74/0833; H04L 5/0055

(57) ABSTRACT

Various communication systems may benefit from suitable acknowledgement mechanisms. For example, wireless communication systems may benefit from methods and mechanisms for acknowledgement of a system information request. A method can include determining how to provide requested system information to a user equipment. The method can also include indicating to the user equipment whether the user equipment is to move to a connected mode or to stay in an idle or inactive mode to receive the system information.

### CROSS REFERENCE TO RELATED APPLICATION

This application claims priority to U.S. Provisional Patent Application No. 62/524,122 filed on Jun. 23, 2017. The entire content of the above-referenced application is hereby incorporated by reference.

### BACKGROUND

### Field

Various communication systems may benefit from suitable acknowledgement mechanisms. For example, wireless communication systems may benefit from methods and mechanisms for acknowledgement of a system information request.

### Description of the Related Art

For a third generation partnership project (3GPP) new radio (NR) system, as described in 3GPP TS 38.804, for a message 1 (Msg1) based system information (SI) request, the minimum granularity of requested SI may be one SI message, corresponding to a set of system information blocks (SIBs) as in long term evolution (LTE). Moreover, for a MSG1-based SI request, one random access channel (RACH) preamble can be used to request multiple SI messages.

An on-demand SI request can have commonality with the RACH procedure. The network sends an acknowledgement in message 2 (Msg2) to the SI request sent in Msg1 by the user equipment (UE). Moreover, the network may send an acknowledgement in message 4 (Msg4) to the UE's SI request sent in message 3 (Msg3). The RA Msg3-based request for SI can also be acknowledged by the network (NW) via Msg4.

Upon the UE's request via random access (RA) procedure, either Msg1-based or Msg3-based, the network (NW) will acknowledge the UE's request which serves as a successful completion of the SI-request RA procedure for the UE. With the Msg3 type of solution, the NW can identify the UE along with the request as the UE indicates its UE ID in the Msg3 transmission.

The NW may either broadcast the requested SI in the cell or the UE should move to connected mode to receive the SI via unicast signaling. In case the radio access network (RAN) is successful in retrieving and verifying the UE context, MSG4 should be ciphered and sent on SRB1.

### SUMMARY

According to certain embodiments, an apparatus may include at least one memory including computer program code, and at least one processor. The at least one memory and the computer program code may be configured, with the at least one processor, to cause the apparatus at least to determine how to provide requested system information to a user equipment. The at least one memory and the computer program code may also be configured, with the at least one processor, to cause the apparatus at least to indicate to the user equipment whether the user equipment is to move to a connected mode or to stay in an idle or inactive mode to receive the system information.

An apparatus, in certain embodiments, may include means for determining how to provide requested system information to a user equipment. The apparatus may also include means for indicating to the user equipment whether the user equipment is to move to a connected mode or to stay in an idle or inactive mode to receive the system information.

According to certain embodiments, a non-transitory computer-readable medium encoding instructions that, when executed in hardware, perform a process. The process may include determining how to provide requested system information to a user equipment. The process may also include indicating to the user equipment whether the user equipment is to move to a connected mode or to stay in an idle or inactive mode to receive the system information.

According to certain other embodiments, a computer program product may encode instructions for performing a process. The process may include determining how to provide requested system information to a user equipment. The process may also include indicating to the user equipment whether the user equipment is to move to a connected mode or to stay in an idle or inactive mode to receive the system information.

An apparatus, according to certain embodiments, may include circuitry for determining how to provide requested system information to a user equipment. The apparatus may also include circuitry for indicating to the user equipment whether the user equipment is to move to a connected mode or to stay in an idle or inactive mode to receive the system information.

According to certain embodiments, an apparatus may include at least one memory including computer program code, and at least one processor. The at least one memory and the computer program code may be configured, with the at least one processor, to cause the apparatus at least to request system information from a network. The at least one memory and the computer program code may also be configured, with the at least one processor, to cause the apparatus at least to receive from the network response to the request an indication of whether the user equipment is to move to a connected mode or to stay in an idle or inactive mode to receive the system information.

An apparatus, in certain embodiments, may include means for requesting system information from a network. The apparatus may also include means for receiving from the network response to the request an indication of whether the user equipment is to move to a connected mode or to stay in an idle or inactive mode to receive the system information.

According to certain embodiments, a non-transitory computer-readable medium encoding instructions that, when executed in hardware, perform a process. The process may include requesting system information by a user equipment from a network. The process may also include receiving at the user equipment from the network response to the request an indication of whether the user equipment is to move to a connected mode or to stay in an idle or inactive mode to receive the system information.

According to certain other embodiments, a computer program product may encode instructions for performing a process. The process may include requesting system information by a user equipment from a network. The process may also include receiving at the user equipment from the network response to the request an indication of whether the user equipment is to move to a connected mode or to stay in an idle or inactive mode to receive the system information.

An apparatus, according to certain embodiments, may include circuitry for requesting system information from a network. The apparatus may also include circuitry for receiving from the network response to the request an indication of whether the user equipment is to move to a connected mode or to stay in an idle or inactive mode to receive the system information.

According to a certain embodiments, a method may include sending a request from a master node to a secondary node to report measurement results or a recommendation for a target node for the secondary node. The master node may wait to receive the measurement results or the recommendation for the target node from the secondary node. The method may also include determining at the master node to release the secondary node or to change the secondary node to the target node after waiting to receive the measurement results or the recommendation for the target node.

According to certain embodiments, a method can include determining how to provide requested system information to a user equipment. The method can also include indicating to the user equipment whether the user equipment is to move to a connected mode or to stay in an idle or inactive mode to receive the system information.

In a variant, the method can further include receiving a request for system information. The determination of how to provide the requested system information can be based on the request.

In a variant, the indication to the user equipment can be in an acknowledgement message.

In a variant, the indication can indicate connected mode when the user equipment is to receive the system information via dedicated signaling.

In a variant, the indication can indicate idle or inactive mode when the user equipment is to receive the system information via system information broadcast.

In a variant, a request for the system information can be received as a request for on demand system information together with a request for higher layer data service.

In a variant, the method can further include providing the on demand system information in a radio resource control connected mode with dedicated signaling parallel with higher layer signaling.

In another variant, the indication may be a parameter or an information element included in either a message 2 or message 4 of a random access procedure.

According to certain embodiments, a method can include requesting system information by a user equipment from a network. The method can also include receiving at the user equipment from the network response to the request an indication of whether the user equipment is to move to a connected mode or to stay in an idle or inactive mode to receive the system information.

In a variant, the requesting system information comprises requesting on demand system information together with requesting higher layer data service.

In a variant, the method can further include receiving the on demand system information in a radio resource control connected mode with dedicated signaling parallel with higher layer signaling.

In a variant, the requesting system information can be included in either message 1 or message 3.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

### DETAILED DESCRIPTION

Certain embodiments relate to the on-demand system information delivery agreed for the 3GPP NR system. More specifically, certain embodiments relate to the NW acknowledgement for UE's SI request and how the UE should behave. Certain embodiments may also be applicable to other systems, and thus this particular system should be understood to be one example of such systems.

In some cases, a single UE or very few UEs may request system information in the cell. The few UEs may be located in different beams within the cell. In such a case, using the broadcast option may be expensive in terms of system resources use. However, conventionally there is no mechanism for the NW to make the UEs move to connected mode to receive the requested SI.

Additionally, certain embodiments address a situation in which a UE needs to request on demand system information but simultaneously has need for higher layer service needs for data transfer. For example, the higher layer needs may be for non-access stratum (NAS) signaling such as for a tracking area update (TAU), radio access network (RAN) signaling such as for a RAN area update, or a user plane data service. In such a case, first requesting on demand system information before initiating high layer service data transfers can introduce unacceptable delay for high layer data transfers.

Certain embodiments let the NW decide how to provision the requested system information for the UE. For example, the NW may indicate in an Msg2/Msg4 acknowledgement message whether the UE should move to CONNECTED mode to receive the SI via dedicated signaling or keep in IDLE/INACTIVE mode to receive the SI via the system information broadcast.

Additionally, when the UE has need for on demand system information and higher layer data service, the UE can indicate both requests to the NW simultaneously. The NW can provide on demand system information in RRC connected mode with dedicated signaling parallel with higher layer signaling.

The above embodiments can be implemented in various ways. For example, when the UE has only an on demand system information request need, the UE can indicate this need in either MSG1 or by MSG3, based on network configuration provided by minimum system information.

When the UE has both an on demand system information request and a higher layer data transfer need, such as NAS signaling, RAN signaling, or application data, the UE can indicate the need of on demand system information in Msg3. Even though the Msg1 approach may be configured, the UE can still use the Msg3 approach.

For the approach in which there is to be dedicated signaling based on a Msg1 indicated need, the NW may respond to the UE's SI request with the random access preamble ID (RAPID) used for the SI-request and indicate with a flag that the UE should use the Msg3 approach instead. In one additional option, the NW may indicate in a random access response (RAR) when the NW starts broadcasting the system information corresponding to the MSG1 request. In other embodiments, the response can be used to inform UE that the UE should initiate a new RACH procedure, based on the normal procedure, to access connected mode.

Alternatively, this indication may be common to all SI-requests by the UE(s). For example, the indication may be applicable to all RAPIDs.

For the approach in which there is to be dedicated signaling based on a Msg3 indicated need, the NW may respond to the UE's SI request with RRCConnectionSetup for an idle mode request messages, or with RRCConnectionResume for an inactive mode request messages, to move the UE to connected mode. The network may then signal the on demand system information normally via signaling radio bearer 1 (SRB #1) by using acknowledged mode radio link control (AM-RLC) signaling.

Alternatively/additionally for the inactive mode UEs, the NW may respond with RRCConnectionRelease type of message including the requested SI message and possibly a new inactive configuration. This option may benefit from the fact that the MSG4 can be sent ciphered to the inactive mode UEs.

Alternatively/additionally for UE having both higher layer signaling need, such as NAS/RAN signaling and/or application data, and on demand system information, the network can move the UE into RRC connected mode and can signal on demand system information in parallel by using medium access control (MAC) multiplexing or then within the same RRC message with higher layer signaling/application data. The priority of the on demand system information may be different, either lower or higher, than the higher layer signaling/application data.

In one option, the SI may be provided via another SRB configured for the UE, such as SRB2, which can have lower priority to the SRB1 or certain configured data radio bearers (DRBs).

In one option, the NW may indicate for the UE in connected mode, that the SI the UE is requesting will be provided later on, for example once the high priority data/signaling has been done. The indication could be in the form of a one bit indication in an RRC connection reconfiguration message.

For the approach in which there is to be system information broadcast based on a Msg3 indicated need, the NW may respond to the UE's SI request with RRCConnectionReject. This response message can include an indication that the SI request was successful. If the indication is set, the UE can attempt to receive the requested SI via broadcast signaling.

The NW may reject the request without setting the indication. Such a rejection can mean that the NW is loaded. In this case, the rejection may not serve as an acknowledgement for the UE's request.

The UE's SI request via Msg3 solution can be based on the RRCConnectionRequest (idle mode UE) or RRCConnectionResumeRequest (inactive mode UE) type of messages. The UE may indicate in the establishment cause that the UE is requesting on demand SI.

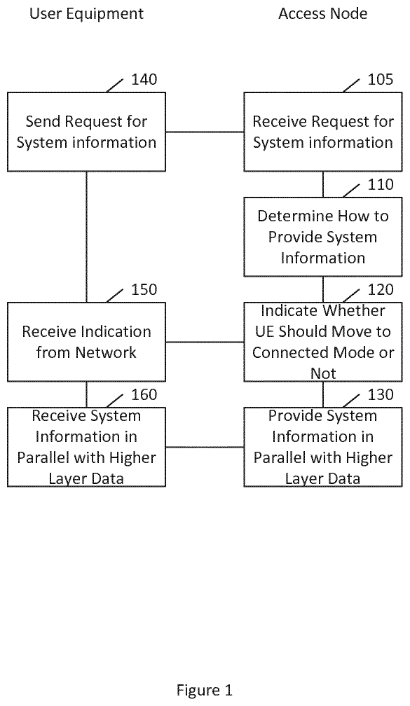

FIG. 1 illustrates a method according to certain embodiments. As shown in FIG. 1, a method can include, at 110, determining how to provide requested system information to a user equipment. The method can also include, at 120, indicating to the user equipment whether the user equipment is to move to a connected mode or to stay in an idle or inactive mode to receive the system information.

The indication to the user equipment can be in an acknowledgement message. The indication can indicate connected mode when the user equipment is to receive the system information via dedicated signaling. The indication can indicate idle or inactive mode when the user equipment is to receive the system information via system information broadcast.

The method can further include, at 105, receiving a request for system information. The determination of how to provide the requested system information can be based on the request. The request for the system information can be received as a request for on demand system information together with a request for higher layer data service. The method can further include, at 130, providing the on demand system information in a radio resource control connected mode with dedicated signaling parallel with higher layer signaling.

The method can also include, at 140, requesting system information by a user equipment from a network. The method can also include, at 150, receiving at the user equipment from the network response to the request an indication of whether the user equipment is to move to a connected mode or to stay in an idle or inactive mode to receive the system information.

The requesting system information can include requesting on demand system information. The method can further include, at 160, receiving the on demand system information in a radio resource control connected mode with dedicated signaling. In a variant, the requesting system information can be done in either message 1 or message 3, as described above.

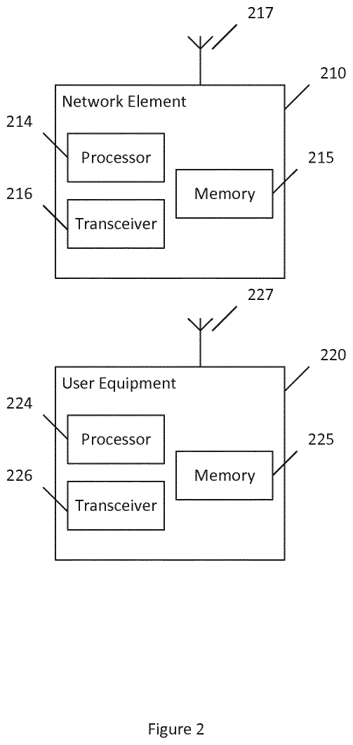

FIG. 2 illustrates a system according to certain embodiments of the invention. It should be understood that each block of the flowchart of FIG. 1 may be implemented by various means or their combinations, such as hardware, software, firmware, one or more processors and/or circuitry. In one embodiment, a system may include several devices, such as, for example, network element 210 and user equipment (UE) or user device 220. The system may include more than one UE 220 and more than one network element 210, although only one of each is shown for the purposes of illustration. A network element can be an access node, an access point, a base station, an eNode B (eNB), next generation NodeB (gNB), or any other network element.

Each of these devices may include at least one processor or control unit or module, respectively indicated as 214 and 224. At least one memory may be provided in each device, and indicated as 215 and 225, respectively. The memory may include computer program instructions or computer code contained therein, for example for carrying out the embodiments described above. One or more transceiver 216 and 226 may be provided, and each device may also include an antenna, respectively illustrated as 217 and 227. Although only one antenna each is shown, many antennas and multiple antenna elements may be provided to each of the devices. Other configurations of these devices, for example, may be provided. For example, network element 210 and UE 220 may be additionally configured for wired communication, in addition to wireless communication, and in such a case antennas 217 and 227 may illustrate any form of communication hardware, without being limited to merely an antenna.

Transceivers 216 and 226 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 220 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof. The user device or user equipment 220 may be a sensor or smart meter, or other device that may usually be configured for a single location.

In an exemplifying embodiment, an apparatus, such as a node or user device, may include means for carrying out embodiments described above in relation to FIG. 1.

Processors 214 and 224 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof. The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 215 and 225 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 210 and/or UE 220, to perform any of the processes described above (see, for example, FIG. 1). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

In certain embodiments, an apparatus may include circuitry configured to perform any of the processes or functions illustrated in FIGS. 1-7. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

Furthermore, although FIG. 2 illustrates a system including a network element 210 and a UE 220, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may provide ways and mechanisms for the NW to decide on the fly how to provision the on-demand SI requested to the UE via dedicated signaling, moving the UE into connected mode, or via system information broadcast, keeping the UE in idle/inactive mode. These mechanisms and ways may let the NW flexibly optimize the on-demand SI transmissions based on the current situation in the cell(s).

Moreover, certain embodiments may provide for parallel operation between on demand system information and NAS signaling, RAN signaling, or application layer data exchange. Thus, certain embodiments may minimize higher layer data transaction time and thus device power consumption, by eliminating on demand system information acquisition time.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### List of Abbreviations

RA Random Access
RACH Random Access Channel
RAPID Random Access Preamble ID
SI System Information
RAR Random Access Response
MSG1 Message 1 of the 4 Step Random Access Procedure (RA preamble transmitted by UE)
MSG2 Message 2 of the 4 Step Random Access Procedure (RAR message as response to MSG1 transmitted by NW)
MSG3 Message 3 of the 4 Step Random Access Procedure (UE transmission on allocated grant given in MSG2 by network)
UE User Equipment
NAS Non Access Stratum
RAN Radio Access Network

1. A method comprising:
determining how to provide requested system information to a user equipment; and
indicating to the user equipment whether the user equipment is to move to a connected mode or to stay in an idle or inactive mode to receive the system information.

2. The method according to claim 1, further comprising:
receiving a request for system information, wherein the determination of how to provide the requested system information is based on the request.

3. The method according to claim 1, wherein the indication to the user equipment is included in an acknowledgement message.

4. The method according to claim 1, wherein the indication indicates connected mode when the user equipment is to receive the system information via dedicated signaling.

5. The method according to claim 1, the indication indicates idle or inactive mode when the user equipment is to receive the system information via system information broadcast.

6. The method according to claim 1, wherein a request for the system information is received as a request for on demand system information.

7. The method according to any of claim 6, further comprising:
providing the on demand system information in a radio resource control connected mode with dedicated signaling.

8. The method according to claim 1, wherein the indication is a parameter or an information element included in either a message 2 or message 4 of a random access procedure.

9. A method comprising:
requesting system information by a user equipment from a network; and
receiving at the user equipment from the network response to the request an indication of whether the user equipment is to move to a connected mode or to stay in an idle or inactive mode to receive the system information.

10. The method according to claim 9, wherein the requesting system information comprises requesting on demand system information together with requesting higher layer data service.

11. The method according to claim 9 or 10, further comprising:
receiving the on demand system information in a radio resource control connected mode with dedicated signaling parallel with higher layer signaling.

12. The method according to claim 9, wherein the requesting system information is included in either a message 1 or a message 3 of a random access procedure.

13. An apparatus comprising:
at least one memory comprising computer program code; and
at least one processor;
wherein the at least one memory and the computer program code are configured, with the at least one processor, to cause the apparatus at least to:
determine how to provide requested system information to a user equipment; and
indicate to the user equipment whether the user equipment is to move to a connected mode or to stay in an idle or inactive mode to receive the system information.

14. The apparatus according to claim 13, wherein the at least one memory and the computer program code are configured, with the at least one processor, to cause the apparatus at least to:
receive a request for system information, wherein the determination of how to provide the requested system information is based on the request.

15. The apparatus according to claim 13, wherein the indication to the user equipment is included in an acknowledgement message.

16. The apparatus according to claim 13, wherein the indication indicates connected mode when the user equipment is to receive the system information via dedicated signaling.

17. The apparatus according to claim 13, the indication indicates idle or inactive mode when the user equipment is to receive the system information via system information broadcast.

18. The apparatus according to claim 13, wherein a request for the system information is received as a request for on demand system information.

19. The apparatus according to claim 13, wherein the at least one memory and the computer program code are configured, with the at least one processor, to cause the apparatus at least to:
provide the on demand system information in a radio resource control connected mode with dedicated signaling.

20. The apparatus according to claim 13, wherein the indication is a parameter or an information element included in either a message 2 or message 4 of a random access procedure.
